(19) United States
(12) Patent Application Publication
(10) Pub. No.: US 2024/0282471 A1
(43) Pub. Date: Aug. 22, 2024

(54) METHOD FOR DIAGNOSING THE LIFESPAN OF A PRESSURE VESSEL AND LIFESPAN DIAGNOSIS SOLUTION

(71) Applicant: MACTEC Corp., Daejeon (KR)

(72) Inventor: Young Suk KIM, Daejeon (KR)

(21) Appl. No.: 18/440,913

(22) Filed: Feb. 13, 2024

(30) Foreign Application Priority Data
Feb. 20, 2023 (KR) 10-2023-0022394

(51) Int. Cl. G21C 17/003; G01N 25/00; G01N 25/20

(52) U.S. Cl. CPC G21C 17/003; G01N 25/005; G01N 25/20

(57) ABSTRACT

According to one embodiment disclosed in the present inventive concept, a method for diagnosing the lifespan of a pressure vessel is disclosed. The method for diagnosing the lifespan of the pressure vessel includes the steps of extracting a calorimetric sample from the pressure vessel or a surveillance test specimen, measuring the enthalpy amount, changes in the enthalpy amount, the specific heat capacity, or changes in the specific heat capacity of the extracted calorimetric sample; determining the amount of entropy change in the calorimetric sample based on the measured enthalpy amount, the measured changes in the enthalpy amount, the measured specific heat capacity, or the measured changes in the specific heat capacity; and determining the remaining lifespan of the pressure vessel based on the amount of entropy change in the calorimetric sample. In addition, various embodiments discernible through the specification are possible.

### BACKGROUND

### Technical Field

Embodiments disclosed include a method for diagnosing the lifespan of a pressure vessel and lifespan diagnosis solution.

### Background of the Related Art

Nuclear power plants have a design life of 40 or 60 years, and if their life is extended, they can operate for up to 60 or 80 years. During their extended operations, the most important thing is aging and sustainability of all the structural components used in nuclear power plants. For example, replaceable components or structures can be replaced when they reach the end of their lifespan, but non-replaceable components or structures, such as pressure vessels, cannot be replaced. Therefore, the lifespan of a nuclear power plant can be considered to be determined by the lifespan of its pressure vessel.

Pressure vessel steel is a low-alloy steel containing small amounts of Mn, Ni, Mo or Cr elements (less than 2 wt. %) or a type of carbon steel with high strength and toughness. Pressure vessel steel is exposed to high temperatures, such as the primary coolant (hot water at 280 to 300° C.), and fast neutrons with energies greater than 1 MeV (E>1 MeV) emitted from nuclear fuel during operation. Due to operation under these harsh conditions, pressure vessels undergo embrittlement due to neutron irradiation and thermal aging. As a result, as indicated in FIG. 3, the reference temperature for nil ductility transition (RTNDT) of the pressure vessel, such as the ductile-brittle transition temperature, increases, while the upper shelf energy (USE) decreases. Countries operating nuclear power plants, including the Republic of Korea, have regulations governing the conduct of surveillance tests on pressure vessels and the assessment of their results. For example, the Republic of Korea's “Regulations on Inspection and Evaluation of Reactor Pressure Vessels” (Nuclear Safety and Security Commission Notice No. 2021-28) stipulates that if the results of a pressure vessel surveillance test show that the USE on the Charpy impact test curve is below 68 J or the RTNDT increases to above 93° C., the operation of the pressure vessel and the nuclear power plants containing it shall be suspended.

### SUMMARY

The utilities of nuclear power plants deploy a surveillance capsule including pressure vessel surveillance test specimens and neutron dosimetry monitors inside the reactor vessel to monitor the aging of the pressure vessel steel. They construct a model for evaluating the lifespan of pressure vessels using the surveillance capsule. Specifically, the evaluation method involves subjecting the surveillance specimens to relatively short-term exposure to a high neutron irradiation fluence corresponding to the vessel's design life (e.g., 80 years). Subsequently, these surveillance test specimens are destructively tested to determine an increase in the RTNDT and a decrease in the USE based on neutron irradiation fluence. Using this data, the remaining life span of the pressure vessel is determined. However, recent research results suggest that the RTNDT of pressure vessel specimens determined at the high neutron flux of experimental reactors is lower than that of specimens in the low neutron flux of actual operating commercial reactors. In other words, the model established based on the elevated RTNDT due to high neutron irradiation fluence in experimental reactors is not found to be conservative.

The present inventive concept introduces practical examples with a goal of ensuring sufficient conservatism and outlining a diagnostic method for assessing the lifespan of a nuclear reactor pressure vessel based on its embrittlement mechanism.

According to the embodiments disclosed in the present inventive concept, a method for diagnosing the lifespan of a nuclear reactor pressure vessel is disclosed. The method for diagnosing the lifespan of the nuclear reactor pressure vessel may include the steps:
extracting the calorimetric sample for differential scanning calorimetry (DSC) analysis from the aforementioned pressure vessel;
measuring the enthalpy amount, changes in the enthalpy amount, the specific heat capacity, or changes in the specific heat capacity of the extracted calorimetric sample;
determining the amount of entropy change based on the measured enthalpy amount, the measured changes in the enthalpy amount, the measured specific heat capacity or the measured changes in the specific heat capacity; and
determining the remaining lifespan of the pressure vessel based on the amount of entropy change.

In describing exemplary embodiments in detail, the step for determining the remaining lifespan of the pressure vessel may be performed based on at least one of the RTNDT and the USE.

In detailing exemplary embodiments, the calorimetric samples are extracted from the inner surface of the pressure vessel. The step for determining the remaining lifespan of the pressure vessel includes determining the RTNDT or the USE of the calorimetric sample and correcting the determined RTNDT or the USE of the calorimetric sample based on correction variables. These correction variables may include temperature and neutron irradiation fluence at an internally designated location on the inner surface relative to the location from which the calorimetric sample was extracted.

In various embodiments, the step of determining the remaining lifespan of the pressure vessel can be established through the lifespan diagnosis solution below as:

### [Lifespan Diagnosis Solution]

$${t}_{L} = {k ( {H}_{L} / {H}_{0} ) [ ( {T}_{P} - T ) / {T}_{P} ]}^{2} exp [ ( {Q}_{Δ S} / R ( 1 / T - 1 / {T}_{P} ) ] or$$

$${t}_{L} = {k ( \vert Δ {S}_{L} \vert / \vert Δ {S}_{0} \vert ) [ ( {T}_{P} - T ) / {T}_{P} ]}^{2} exp [ ( {Q}_{Δ S} / R ( 1 / T - 1 / {T}_{P} ) ] ,$$

where k is an intrinsic constant, Q_{ΔS} is an activation energy for entropy decrease for the pressure vessel, T is an operating temperature in K, T_{P} is the peak temperature where the maximum enthalpy amount is released in K, H_{L} is a threshold enthalpy amount determined by the smaller value between reaching the RTNDT of 93° C. and reaching the USE of 68 J for the pressure vessel or the surveillance test specimen, H₀ is the enthalpy amount measured at any given time for the pressure vessel or the surveillance test specimen, |ΔS_{L}| is the absolute value of the threshold entropy change or the threshold entropy, determined by the smaller value between reaching the RTNDT of 93° C. and reaching the USE of 68 J for the pressure vessel or the surveillance test specimen, and |ΔS₀| is the absolute value of entropy change or entropy at any given time. Both |ΔS_{L}| and |ΔS₀| are determined from the measured specific heat capacity or the measured changes in the specific heat capacity.

The method for diagnosing the remaining lifespan of a nuclear reactor pressure vessel according to the exemplary embodiments disclosed in the present inventive concept involves directly measuring the accumulated enthalpy amount within the pressure vessel. This eliminates the conservatism in evaluating the extent of pressure vessel embrittlement that may exist in current pressure vessel life evaluation models, especially under high neutron irradiation fluences. Therefore, in comparison to existing life evaluation models, a more accurate and reliable assessment of the remaining lifespan of the pressure vessel can be achieved. It is important to note that the present inventive concept may be embodied in various forms and should not be construed as limited to the examples provided herein. Instead, these embodiments are provided to ensure thoroughness and completeness in conveying the scope of the inventive concept to those skilled in the art.

### BRIEF DESCRIPTION OF THE DRAWINGS

FIG. 1 is a diagram illustrating the method for diagnosing the remaining lifespan of a pressure vessel according to an exemplary embodiment.

FIG. 2 is a diagram illustrating the method for constructing and verifying a lifespan diagnosis solution for a pressure vessel according to an exemplary embodiment.

FIG. 3 is a diagram illustrating changes in the RTNDT and the USE of a pressure vessel due to neutron irradiation embrittlement.

FIG. 4 is a diagram illustrating the impact energy of Fe-0.117% C carbon steel obtained at different cooling rates.

FIG. 5 is a diagram illustrating the thermograms of water-quenched (WQ−) and furnace-cooled (FC−) carbon steel containing 0.23% carbon (Fe-0.23% C).

FIG. 6 is a diagram illustrating the calorimetric behaviors of a bulk metallic glass measured by DSC. Here, ‘a’ represents the cast specimen and ‘b’, ‘c’, ‘d’, ‘e’, ‘f’, ‘g’, and ‘h’ represent the thermograms of the specimens heated to temperatures of 600K, 625K, 650K 675K, 700K, 725K, and 750K, respectively, and then rapidly cooled at a rate of 1.66 K/s.

FIG. 7 is a diagram illustrating the density changes in cast bulk metallic glass after either heat treatment at different heating temperatures or heat treatment at 675K for varying times followed by cooling.

FIG. 8 is a diagram showing the volume reduction obtained from the density changes presented in FIG. 7, when plotted as a function of enthalpy change obtained from FIG. 6.

FIG. 9 is a diagram showing the change in the heat absorption behavior of a bulk metallic glass as a function of heat treatment time at 281° C. In FIG. 8, ‘1’ represents the initial heat absorption behavior of the as-quenched specimen before heat treatment.

FIG. 10 is a diagram illustrating the increase in the ductile-brittle transition temperature of the bulk metallic glass with increasing amount of heat absorption.

FIG. 11 is a diagram illustrating a linear relationship between the increasing amount of the RTNDT and the atomic cluster volume fraction for the pressure vessel surveillance test specimens.

FIG. 12 is a diagram illustrating the impact energy behavior of water-quenched carbon steel as a function of carbon concentration.

FIG. 13 is a diagram illustrating the impact energy behavior of Fe-0.05% C carbon steel water-quenched after annealing at 950° C. as a function of manganese concentration.

FIG. 14 is a diagram illustrating specific heat capacities of unaged and aged asphalts at 185° C. for 50 h.

FIG. 15 is a diagram illustrating Young's moduli of unaged and aged asphalts at 185° C. for 50 h.

Regarding the explanation of the diagrams, the same or similar reference symbols may be used for the same or similar components.

### DETAILED DESCRIPTION OF THE PREFERRED EMBODIMENT

Hereinafter, various exemplary embodiments of the present inventive concept are described with reference to attached Figures. However, this is not intended to limit the present inventive concept to a particular embodiment, and it should be understood to encompass various modifications, equivalents and/or alternatives to the exemplary embodiments of the present inventive concept.

In the following sections, the pressure vessel disclosed in the present inventive concept may include pressure vessels used for various purposes. For example, the pressure vessel can include any of the types of pressure vessels specified in Safety Inspection Notice 2020-43 in the Republic of Korea, such as a nuclear reactor pressure vessel located inside a nuclear reactor, a high-pressure gas vessel, or a vessel filled with hazardous chemicals. As an example, the pressure vessel might be a tank filled with high-pressure liquefied natural gas (LNG) or hazardous chemicals. The pressure vessel is not limited to examples described above.

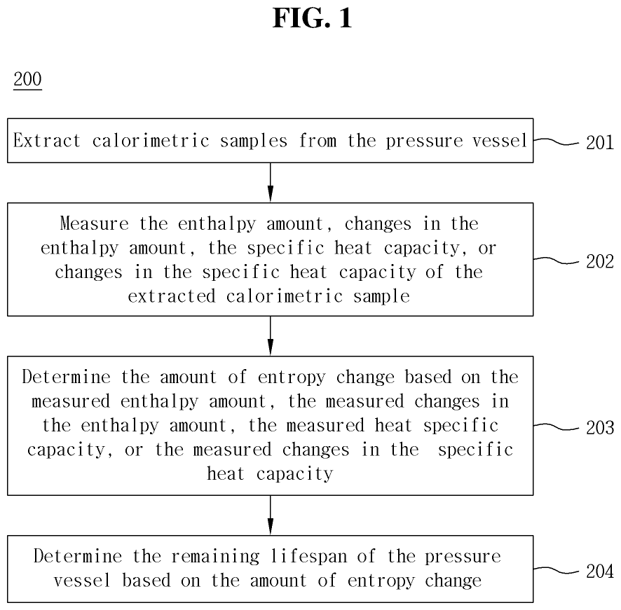

FIG. 1 is a diagram illustrating the methods for diagnosing the remaining lifespan of a pressure vessel, according to the embodiment. The method for diagnosing the remaining lifespan of a nuclear reactor pressure vessel according to embodiment (200), may include the following steps: (201) extracting calorimetric samples from the pressure vessel or the surveillance test specimen, (202) measuring the enthalpy amount, changes in the enthalpy amount, the specific heat capacity, or changes in the specific heat capacity of the extracted calorimetric samples, (203) determining the amount of entropy change in the pressure vessel based on the measured enthalpy amount, the measured changes in the enthalpy amount, the measured specific heat capacity, or the measured changes in the specific heat capacity and (204) determining the remaining lifespan of the pressure vessel based on the measured amount of entropy change.

In one embodiment, during the step (201) of extracting calorimetric samples from the pressure vessel, these samples can be obtained from the inner surface of the pressure vessel. For example, the calorimetric samples can be extracted from both the base metal and/or the weld region of the pressure vessel. In various embodiments, the calorimetric samples may be provided in the form of thin plates, approximately ˜20 μm thick. In cases where extracting calorimetric samples directly from the inner surface of the pressure vessel is not feasible due to cladding, alternative sources include obtaining them from surveillance test specimens which can effectively represent pressure vessel embrittlement.

In one embodiment, the step (202) of measuring the enthalpy amount, changes in enthalpy amount, the specific heat capacity, or changes in the specific heat capacity of the pressure vessel may include measuring the enthalpy amount, changes in the enthalpy amount, the specific heat capacity, or changes in the specific heat capacity of the calorimetric samples extracted in step 201. The measurement of the enthalpy amount, changes in enthalpy amount, the specific heat capacity, or changes in the specific heat capacity of the calorimetric samples can be performed using DSC (differential scanning calorimetry).

In one embodiment, the step (203) of determining the amount of entropy change in a pressure vessel can be performed using the following equation (1), based on the enthalpy amount or changes in the enthalpy amount measured in the previous step (202):

$$Δ S = Δ Q / T , \qquad Equation 1$$

where ΔS is the amount of entropy change in J/(g·K), ΔQ is the amount of heat (or enthalpy) or changes in the enthalpy amount of a pressure vessel in J/g or J/mol, T is the temperature in K. For example, if enthalpy or energy of the pressure vessel decreases, resulting in a change (ΔQ) less than 0, according to Eq. (1), the change in entropy of the pressure vessel is also less than 0. In other words, as the enthalpy or energy of the pressure vessel decreases due to aging during the reactor operation, the entropy of the pressure vessel decreases.

$$σ = Q \times ρ \qquad Equation 2$$

$$σ = Δ S \times ρ \times T \qquad Equation 3$$

The units for enthalpy or energy (Q) or changes in enthalpy or energy (ΔQ) are J/mol or J/g, representing mass-based energy density expressed as energy per unit mass. Referring to Eq. 2, multiplying enthalpy or energy (Q) or changes in enthalpy or energy (ΔQ) by density (ρ) yields volume-based energy density, expressed as energy per unit volume, which represents stress in MPa. By combining Eqs. (1) and (2), Eq. 3 can be derived.

According to Eq. (3), a decrease in entropy implies the spontaneous generation of internal compressive stresses, resulting in negative (−) stress. In other words, a decrease in entropy signifies the spontaneous generation of internal compressive stresses. In summary, as the nuclear reactor operates, the enthalpy or energy of the pressure vessel decreases, according to Eq. (1), leading to a reduction in entropy. Neutron irradiation inside the pressure vessel and thermal exposure to high temperatures can cause radiation embrittlement and thermal embrittlement, respectively. These processes reduce the amount of enthalpy or energy in the pressure vessel, leading to a decrease in entropy and, consequently, the formation of internal compressive stresses inside the pressure vessel, as described in Eq. 3. These internally generated compress stresses may act as a driving force for the embrittlement of the pressure vessel.

The same principle can be observed in cases where toffee is stored in a cold refrigerator and becomes hard when chilled (e.g., by removing heat), and when chilled toffee is struck with a hammer, it shatters. The reason the chilled toffee becomes hard is that it has been cooled due to heat removal through refrigeration. According to Eq. (1) mentioned earlier, a decrease in enthalpy or energy (e.g., cooling) leads to a decrease in entropy, which, in turn, according to Eq. (3), results in the spontaneous generation of internal compressive stresses. Therefore, when heat is removed through refrigeration from the toffee, causing a decrease in its entropy, compressive stresses develop internally within the toffee. This, in turn, makes the chilled toffee hard. When the chilled and hard toffee is struck with a hammer, it breaks into several pieces. In other words, the compressive stresses internally induced by the decrease in entropy act as the driving force for the embrittlement of both the pressure vessel and the toffee.

However, if the toffee is heated to above 30° C., increasing its ductility, it will not break even when struck with a hammer. Heating signifies an increase in enthalpy or energy, and according to Eq. 1, an increase in enthalpy or energy means a rise in entropy. According to Eq. 3, this heightened entropy results in the spontaneous generation of internal tensile stresses. Therefore, heating the toffee increases its entropy, which, although not visible to the naked eye, induces tensile stresses internally within the toffee. These internally induced tensile stresses contribute to an increase in the toffee's ductility. This enhanced ductility prevents the toffee from breaking when struck with a hammer.

The same principle applied to materials like carbon steel, commonly referred to as iron. When immersed in liquid nitrogen, and then removed and struck with a hammer, it also shatters into multiple pieces. This phenomenon occurs for the same reason: compressive stresses internally induced by the decrease in entropy serve as the driving force for embrittlement in all materials.

In the exemplary one embodiment, the step (204) of determining the remaining lifespan of the pressure vessel can be executed using the lifespan diagnosis solution outlined in Equations 4 and 5, with reference to either the RTNDT or the USE of the calorimetric sample. Equations 4 and 5, Lifespan diagnosis solutions are expressed as follows

$${t}_{L} = {k ( {H}_{L} / {H}_{O} ) [ ( {T}_{P} - T ) / {T}_{P} ]}^{2} exp [ ( {Q}_{Δ S} / R ( 1 / T - 1 / {T}_{P} ) , \qquad Equation 4$$

$${t}_{L} = {k ( \vert Δ {S}_{L} \vert / \vert Δ {S}_{0} \vert ) [ ( {T}_{p} - T ) / {T}_{P} ]}^{2} exp [ ( {Q}_{Δ S} / R ( 1 / T - 1 / {T}_{P} ) . \qquad Equation 5$$

In Equations 4 and 5, k is a constant, Q_{ΔS} represents the activation energy for entropy decrease, T is the operating temperature in K, T_{P} is the peak temperature where the maximum enthalpy amount is released in K, H_{L} is a threshold enthalpy amount determined by the smaller value between reaching the RTNDT of 93° C. and reaching the USE of 68 J for the pressure vessel or the surveillance test specimen, H₀ is the enthalpy amount measured at any given time for the pressure vessel or the surveillance test specimen, |ΔS_{L}| is the absolute value of the threshold entropy change or the threshold entropy, determined by the smaller value between reaching the RTNDT of 93° C. and reaching the USE of 68 J for the pressure vessel or the surveillance test specimen, and LΔS₀| is the absolute value of entropy change or entropy at any given time.

In Equation 4 of the lifespan diagnosis solution, H_{L} represents the critical amount of enthalpy or energy. This value is determined by measuring the enthalpy or energy after artificially aging the archives of the pressure vessel or the surveillance test specimens in a furnace. The critical amount of enthalpy or energy is defined as the lower of two values: the enthalpy or energy at which the RTNDT of the test specimen increases to reach the critical temperature, or the enthalpy or energy at which the USE decreases to reach the critical value. Similarly, Equation 5 in the lifespan diagnosis solution introduces, |ΔS_{L}| representing the absolute value of the critical entropy change or the critical entropy. This is determined by measuring the specific heat capacity or entropy after artificially aging the archives of the pressure vessel or the surveillance test specimens in a furnace. The critical entropy change or the critical entropy is defined as the lower of two values: the point at which the RTNDT of the test specimen increases to reach the critical temperature, or the point at which the USE decreases to reach the critical value.

In the case of the Republic of Korea, according to the “Regulations on Inspection and Evaluation of Reactor Pressure Vessel” (Nuclear Safety and Security Commission Notice No. 2021-28), the critical temperature is 93° C. and the critical energy value is set at 68 J.

In one embodiment, the step (204) of determining the remaining lifespan can involve determining the RTNDT or USE of the calorimetric sample and may additionally include adjusting the determined RTNDT or USE values.

Adjustment of the determined values can be performed as follows: From the perspective of pressure vessel embrittlement, it is widely known that the ¼ thickness point of the pressure vessel is a conservative location. However, as previously mentioned, calorimetric samples may be extracted from the inner surface of the pressure vessel. The cooling rate and neutron fluence at the conservative point of the pressure vessel may be smaller compared to the inner surface of the pressure vessel.

Therefore, in the step (204) of determining the remaining lifespan of the pressure vessel, the remaining lifespan can be determined based on the adjusted RTNDT and USE, taking into account the cooling rate and neutron irradiation fluence at the conservative location of the pressure vessel.

The step for diagnosing the lifespan of a nuclear reactor pressure vessel according to the exemplary embodiments disclosed in the present inventive concept, involves directly measuring the accumulated enthalpy amount within the pressure vessel. This reduces or prevents a reduction in the conservatism related to embrittlement criteria that can occur at high neutron irradiation fluences in conventional lifetime diagnosis models. Compared to the conventional life evaluation models, this approach allows for a more accurate and safe diagnosis of the remaining lifespan of the pressure vessel.

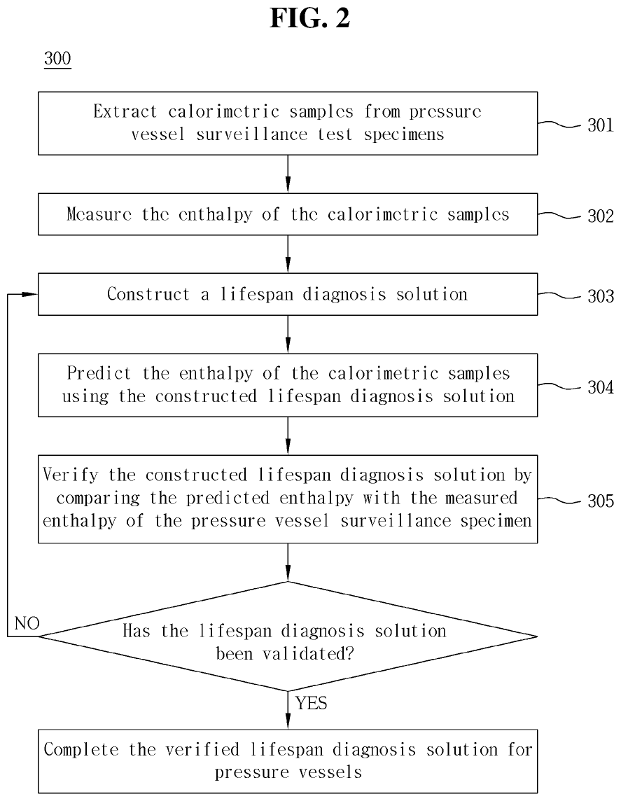

FIG. 2 is a diagram a method for illustrating constructing and verifying a lifespan diagnosis solution for a pressure vessel according to one embodiment. The lifespan diagnosis solution depicted in FIG. 2 can be used to validate the remaining lifespan (referred to as the predicted value) obtained through the method for diagnosing the lifespan of a pressure vessel described in FIG. 1.

Referring to FIG. 2, the method for constructing and verifying the lifespan diagnosis solution (300) involves several steps. First, the calorimetric samples are extracted from the pressure vessel surveillance test specimens (301). Next, the enthalpy amount from the extracted surveillance test specimens is measured (302), and based on this data, a lifespan diagnosis solution is established (303). Following this process, the validity of the established lifespan diagnosis solution can be confirmed.

The verification of the lifespan diagnosis solution (305) involves comparing the measured enthalpy amount of the surveillance tests specimens over operational time with the enthalpy amount predicted by the established lifespan diagnosis solution. For instance, in Step 305, it can be determined whether the predicted values from Step 304 and the measured values from Step 302 exhibit an acceptable level of error. If the difference between the predicted and measured values falls within an acceptable range, it can be concluded that the previously constructed lifespan diagnosis solution has been successfully verified.

However, if the difference between the predicted enthalpy amount and the measured values exceeds an acceptable level, the process may be configured to reconstruct (303) the lifespan diagnosis solution and derive new predicted values (304). In other words, Steps 303, 304 and 305 can be performed iteratively until the difference between the predicted values and the measured values reaches an acceptable level.

Through this verification process, once the lifespan diagnosis solution has been validated, it becomes possible to diagnose the remaining lifespan of an operational pressure vessel. This is achieved by measuring the enthalpy amount of the calorimetric samples extracted either from the inner surface of the operating pressure vessel or from surveillance test specimens for the pressure vessel. The measured enthalpy amount can then be input into the verified lifespan diagnosis solution to assess the remaining lifespan of the operational pressure vessel.

Furthermore, the term ‘surveillance test specimen’ as illustrated in FIG. 2 is not limited to that specific terminology and can encompass various structures prepared for conducting surveillance tests. For example, in the case of the Republic of Korea, surveillance test specimens are required according to the Nuclear Safety and Security Commission Notice No 2021-28. However, the lifetime diagnosis method and solution for pressure vessels, according to the embodiments disclosed in the present inventive concept, can be applied not only in the Republic of Korea but also in various countries with operational or planned nuclear reactors. The terminology used for surveillance test specimens may vary from one country or institution to another.

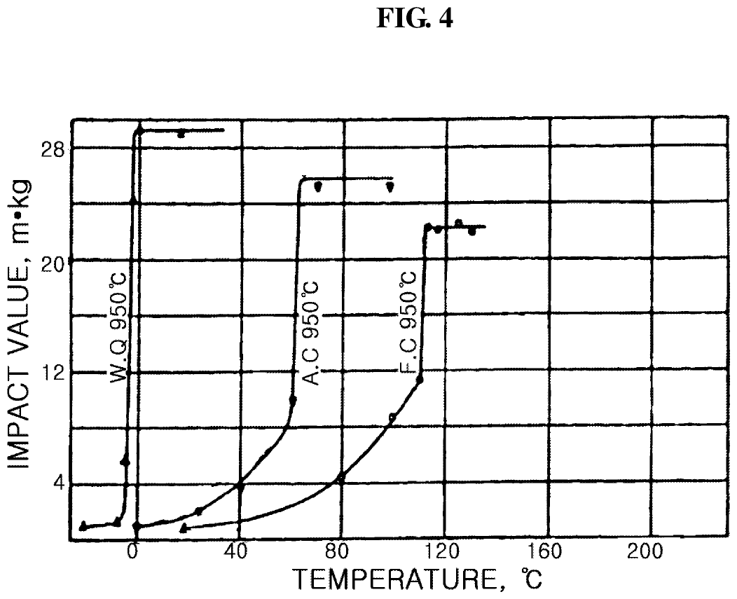

Below, experimental examples are explained, referring to FIGS. 4 through 15 to illustrate the methods for diagnosing the lifespan of a nuclear reactor pressure vessel and the lifespan diagnosis solution according to the exemplary embodiments disclosed in the present inventive concept.

### <Experiment Example 1>: Impact Energy Property of a Carbon Steel with Cooling Rate

A carbon steel with 0.117% C is subjected to water and furnace cooling from 950° C. quenching, air cooling, Subsequently, the fracture toughness of each specimen is measured through Charpy impact tests. Referring to FIG. 4, the water-quenched specimen exhibits the highest USE and the lowest RTNDT (e.g., ductile-to-brittle transition temperature). In other words, the water-quenched carbon steel displays the best impact properties. In contrast, the air-cooled and furnace-cooled carbon steels show lower USE and higher RTNDT compared to the water-quenched specimen. It is noteworthy that as the carbon steel is slowly cooled from 950° C., the USE decreases more significantly, and the RTNDT gradually shifts to higher temperatures.

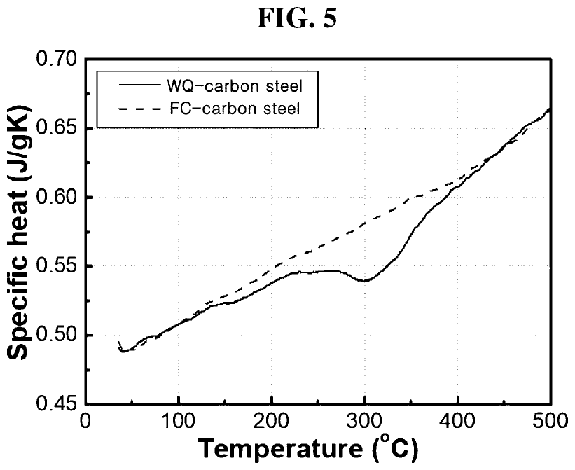

This variation in the impact energy of the carbon steel with different cooling rates can be attributed to differences in their entropy levels resulting from varying cooling rates. To show the entropy levels of the carbon steel with different cooling rates, the specific heat capacities of water-quenched and furnace-cooled carbon steel with 0.23% carbon was measured using DSC. As shown in FIG. 5, the water-quenched specimen exhibits enthalpy release in the high-temperature range above 100° C., a phenomenon absent in the furnace-cooled specimen. Water-quenched carbon steel maintains high entropy during annealing at a high temperature, resulting in minimal enthalpy release due to its rapid cooling rate during water quenching. In contrast, furnace-cooled carbon steel experiences a significant entropy decrease with considerable enthalpy release during furnace cooling. When subjected to calorimetric analysis in a DSC while being heated, the water-quenched carbon steel, initially maintaining high entropy, exhibits enthalpy release as entropy decreases (according to Eq. 1), as shown in FIG. 5. On the other hand, the furnace-cooled carbon steel, having undergone substantial entropy reduction during cooling, does not show enthalpy release. In other words, by tracking the enthalpy behavior of the specimen with a calorimeter, the level of entropy formed within the specimens can be quantitatively determined. According to Eqs. 1 to 3, changes in entropy, such as decreases and increases, enable the spontaneous development of internal compressive and tensile stresses in materials, respectively, which represents a groundbreaking discovery of the present inventive concept. For example, the furnace-cooled carbon steel, not exhibiting enthalpy release when heated, has already undergone a relatively high entropy reduction during furnace cooling. Consequently, it possesses high compressive stresses internally within its structure (Eqs. 1 to 3). These elevated internal compressive stresses enhance the brittleness of furnace-cooled carbon steel, causing it to shift the RTNDT to a higher temperature and a reduction in the USE, as illustrated in FIG. 4. In contrast, the water-quenched carbon steel, initially maintaining high entropy due to minimal enthalpy release during water quenching, develops internal tensile stresses instead of compressive stresses, leading to higher ductility. Consequently, as depicted in FIG. 4, the water-quenched carbon steel has a lower RTNDT and higher USE, leading to the best impact properties compared to the others.

This phenomenon can be easily understood by comparing it to the behavior of toffee. When toffee is cooled in a refrigerator, its entropy decreases due to cooling or heat release. The internal compressive stresses generated by the entropy decrease cause the toffee to harden and become brittle, making it easy to break. On the other hand, when toffee is heated, it experiences internally generated tensile stresses due to the increase in entropy, preventing it from becoming brittle and it remains ductile.

In a similar manner, water-quenched carbon steel, due to its rapid cooling rate, experiences minimal entropy decrease during water quenching, resulting in the generation of internal tensile stresses. This imparts a sticky nature to the steel, giving it a high USE and a low RTNDT, as shown in FIG. 4. In contrast, furnace-cooled carbon steel undergoes significant entropy decrease during furnace cooling, leading to the spontaneous generation of internal compressive stresses, making it hard and resulting in a low USE and a high RTNDT, as shown in FIG. 4. The cooling rate of air-cooled carbon steel is faster than that of furnace-cooled carbon steel and slower than that of water-quenched carbon steel. Therefore, the impact energy characteristics of air-cooled carbon steel, as shown in FIG. 4, lie between those of these two specimens. The results presented in FIGS. 4 and 5, along with the analogy to the behavior of toffee, confirm that entropy changes play a crucial role in determining the RTNDT and the USE of metals. Referring to Eqs. 1 to 3, FIG. 4, and FIG. 5, it becomes evident that the change in entropy is governed by changes in the enthalpy amount. Therefore, monitoring the changes in the enthalpy amount allows for the evaluation of the decrease in impact energy and/or material embrittlement due to aging.

### <Experimental Example 2>: Generation of Internal Compressive Stress and the Embrittlement of the Pressure Vessel Due to Entropy Decrease

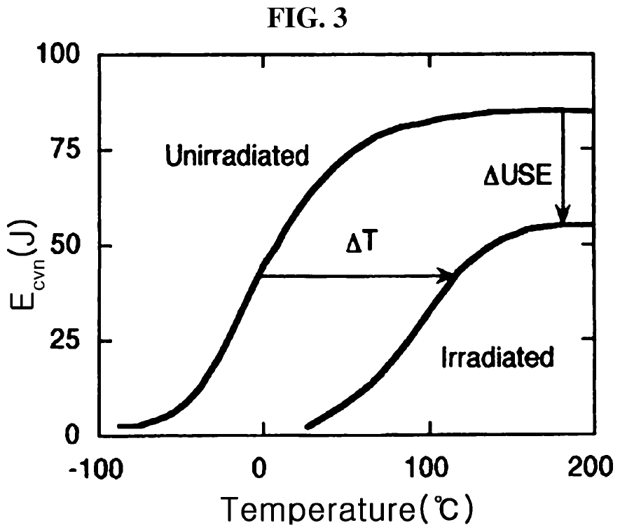

As mentioned in FIG. 3, it is well known that the RTNDT of the nuclear reactor pressure vessel shifts to higher temperatures while the USE decreases, due to the irradiation embrittlement of the pressure vessel. However, the exact cause of this phenomenon remains unclear even to date. As confirmed in Experimental Example 1, the pressure vessel during the initial stages of nuclear reactor operation, akin to the water-quenched carbon steel in FIGS. 4 and 5, initially exhibits a high entropy, resulting in a high USE and a very low RTNDT. However, with prolonged reactor operation time, aging occurs, leading to a decrease in entropy and subsequently a decrease in the enthalpy amount in the pressure vessel. This entropy decrease, manifested as enthalpy release as shown in the case of the furnace-cooled carbon steel (FIGS. 4 and 5), induces internal compressive stresses within the pressure vessel, resulting in its hardening and embrittlement. Consequently, the pressure vessel experiences a decreased USE and a higher RTNDT, similar to the furnace-cooled carbon steel when compared to the water-quenched carbon steel, as illustrated in FIG. 4. It appears that the pressure vessel, like the air-cooled and furnace-cooled carbon steels in FIG. 4, exhibits characteristics of low USE and high RTNDT with the progressing reduction in entropy during extended reactor operation. Therefore, it has been confirmed that the cause pressure vessel embrittlement is the spontaneous development of internal compressive stresses resulting from the entropy decrease manifested by enthalpy release.

The neutron irradiation dose and the operating temperature of the nuclear reactor pressure vessel are crucial factors in determining the amount of entropy decrease in the pressure vessel. The combined effects of neutron irradiation embrittlement and thermal embrittlement at high temperatures determine changes in the enthalpy amount within the pressure vessel. Therefore, by monitoring the changes in the enthalpy amount of the pressure vessel, it is possible to quantitatively evaluate the embrittlement of the pressure vessel.

It is worth noting that the decrease in entropy induces internal compressive stresses within the pressure vessel (Eq. 3), and these internal compressive stresses act as a driving force for the embrittlement of the pressure vessel. Neutron irradiation embrittlement and thermal embrittlement promote enthalpy release from the pressure vessel, ultimately leading to a decrease in entropy within the pressure vessel. In other words, the greater the compressive stress induced by the decrease in entropy, the more the embrittlement of the pressure vessel is promoted, causing the RTNDT to shift to a higher temperature and the USE to decrease further.

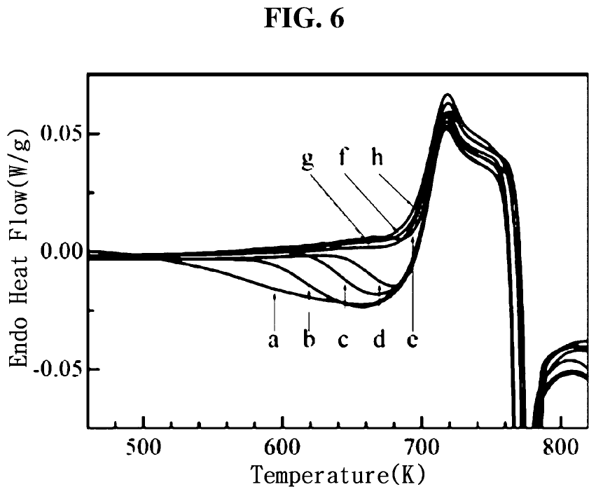

FIGS. 6 to 10 present experimental examples illustrating how enthalpy release induces internal compressive stresses within the material, leading to proportional increases in material density and the ductile-brittle transition temperature. These experiments also demonstrate that as compressive stresses increase due to the growing amount of enthalpy release, the material's volume decreases, and simultaneously, the RTNDT (or ductile-to-brittle transition temperature) shifts to higher temperatures.

FIG. 6 depicts the thermal behaviors of a bulk metallic glass measured by DSC. (a) shows the thermogram of the as-cast specimen. (b), (c), (d), (e), (f), (g), and (h) represent the thermograms of a specimen that was rapidly quenched right after heating to 600K, 625K, 650K, 675K, 700K, 725K, and 750K, respectively.

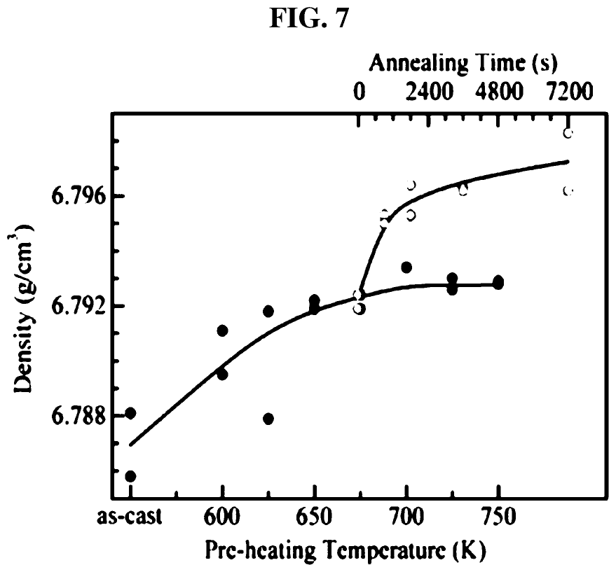

FIG. 7 displays changes in the density of the bulk metallic glass cooled after various heat treatments, as described in FIG. 6, involving different heating temperatures or different heating times at 675K under isothermal conditions.

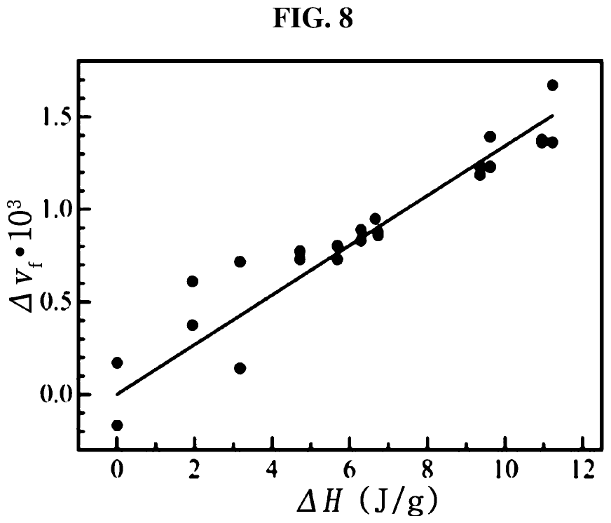

FIG. 8 illustrates the volume decrease of the bulk metallic glass with enthalpy change where the former is determined from the density changes presented in FIG. 7 and the latter is determined from FIG. 6. Note that the amount of enthalpy released is defined as the enthalpy difference between the as-cast and the thermally treated state, and the bulk metallic glass can have a composition of Zr₅₅Cu₃₀Al₁₀Ni₅.

The results presented in FIGS. 6 and 7 experimentally confirm the presence of compressive stresses internally within the material due to entropy decrease. In other words, the increase in bulk metallic glass density with increasing heating temperature is attributed to the spontaneous generation of internal compressive stresses caused by entropy decrease, which gradually increase as the heating temperature rises.

As shown in FIG. 6, the bulk metallic glass exhibits exothermic heat peaks in the temperature range of 460K to 700K and the area under the exothermic peak decreases as the heating temperature increases. This indicates that the enthalpy release of the bulk metallic glass increases with increasing heating temperature. As shown in Eq. 1, a larger amount of enthalpy release corresponds to a greater level of entropy decrease, which, in turn, results in higher compressive stress internally induced in the bulk metallic glass, as described in Eq. 3. As the internally generated compressive stresses increase the density of the bulk metallic glass, the density of the bulk metallic glass is investigated as a function of the amount of enthalpy release. As shown in FIG. 7, when the bulk metallic glass is subjected to heat treatment at different temperatures or for varying durations under isothermal conditions at 675K, its density increases. Referring to FIG. 8, it is evident that the volume contraction of the bulk metallic glass, determined from the density changes in FIG. 7, is directly proportional to the extent of enthalpy change, particularly as the enthalpy change becomes greater. Therefore, the reduction in enthalpy corresponds to a decrease in entropy (Eq. 1), and according to Eq. 3, this reduction in entropy leads to the spontaneous generation of internal compressive stresses. The internally generated compressive stresses act as a driving force to increase the density of the bulk metallic glass, resulting in a decrease in its volume. In summary, FIG. 8 experimentally confirms that entropy decrease induces internal compressive stresses within materials.

### <Experiment Example 3>: Increases in Ductile-to-Brittle Transition Temperature (DBTT) Due to Entropy Decrease

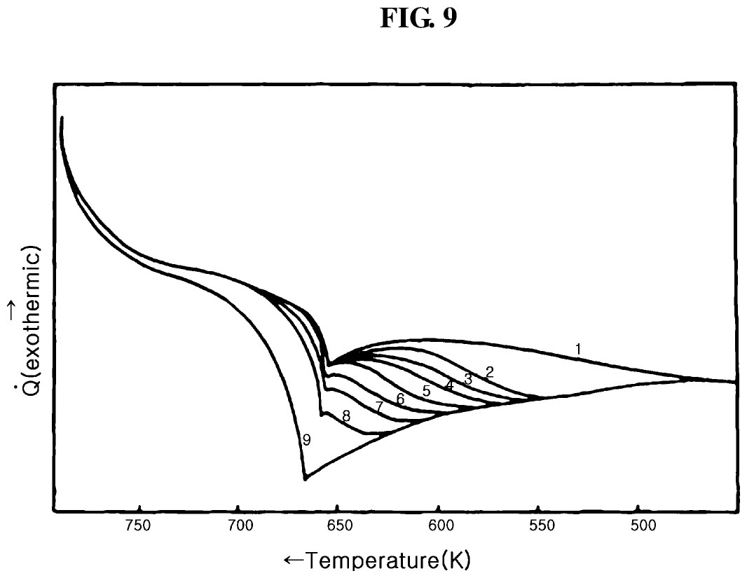

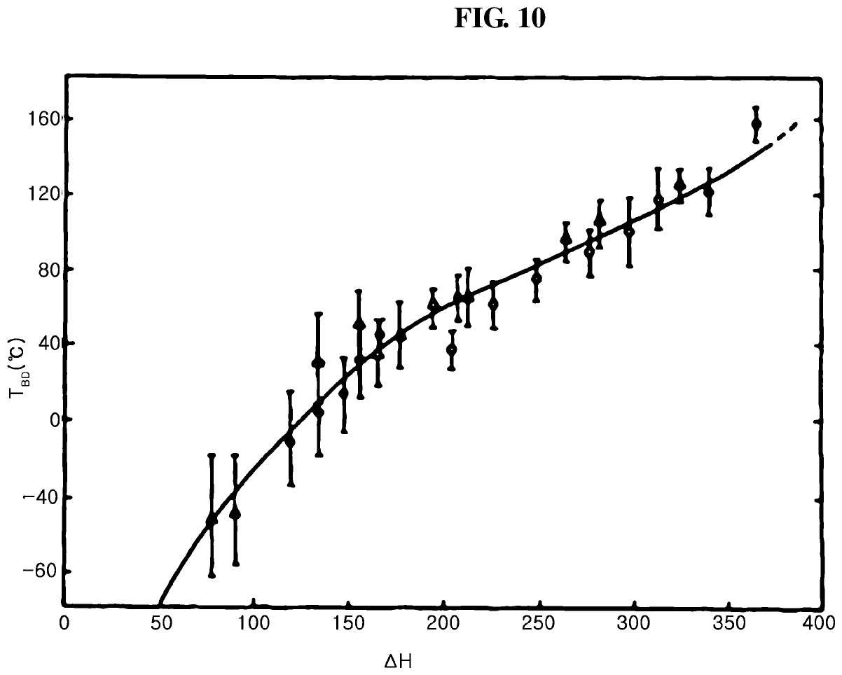

FIG. 9 depicts the variation in heat absorption of a bulk metallic glass as a function of heat treatment time at 281° C. FIG. 10 illustrates an increase in the DBTT (or TBD) of the bulk metallic glass as a function of the increase in heat absorption.

Here, the bulk metallic glass may correspond to Fe_{79.3}B_{16.4}Si_{4.0}C_{0.3}. Number 1 in FIG. 9 represents the as-cast state, which exhibits the lowest heat absorption. The bulk metallic glass was subjected to isothermal treatment in a salt bath, wherein the temperature was initially maintained and then gradually increased while maintaining the sample at each temperature for 2 hours. The DBTT of the heat-treated bulk metallic glass was determined using a bending test in the temperature range of −196° C. to 350° C. The bending fracture strain & is defined as t/(D−t), where t is the thickness of the bulk metallic glass, and D is the distance between the platens of the bend tester. The DBTT is defined as the average temperature of the temperature range showing a sharp change in the bending fracture strain 8. The amounts of absorbed enthalpy in the bulk metallic glass due to heat treatment were measured using DSC.

Referring to FIGS. 9 and 10, it is evident that a decrease in entropy leads to an increase in the DBTT. This correlation is substantiated by examining the impact energy properties of carbon steel with cooling rate, as shown in FIGS. 4 and 5. In FIG. 9, the bulk metallic glass, when heat-treated at high temperatures, exhibits an increased heat absorption proportional to the heat treatment time at 281° C. compared to its as-cast state. The observed increase in heat absorption signifies a concurrent rise in the amount of entropy decrease for the bulk metallic glass. Upon aging, following the complete release of exothermic heat, there is a subsequent occurrence of endothermic heat absorption, despite no change in the exothermic heat release with prolonged aging, as depicted in FIG. 6. Notably, curves f, g, h in FIG. 6 do not show any exothermic peaks but instead display enlarged endothermic peaks upon aging at temperatures above 675K. If the enlarged endothermic peak is a result of increased entropy, as per Eqs. 1 and 3, internally generated tensile stresses arising from the increased entropy would be expected to lead to a decrease in density in the bulk metallic glass. Contrary to this expectation, the observed density of the bulk metallic glass increases with the aging temperature. This suggests that the enlarged endothermic heat observed with increasing aging temperature represents a growing amount of entropy decrease in the bulk metallic glass.

According to Eqs. 1 to 3, a decrease in entropy induces internal compressive stresses, implying that an increase in the amount of entropy decrease corresponds to an increase in compressive stresses. Similar to the case of the carbon steel in FIG. 4, the increase in compressive stresses raises the DBTT of the bulk metallic glass. This observation is supported by the experimental results presented in FIG. 10. Referring to FIG. 10, as the amount of heat (enthalpy) absorption increases, the RTNDT (or DBTT) of the bulk metallic glass also increases. By referencing FIG. 10, it can be concluded that the transition from ductile to brittle behavior in the materials is induced by internal compressive stresses resulting from entropy decrease. As the amount of enthalpy absorption increases, the RTNDT (e.g., DBTT) shifts to a higher temperature while the USE decreases. In summary, the RTNDT and the USE can be determined by tracking changes in the amount of enthalpy released or absorbed by the pressure vessel.

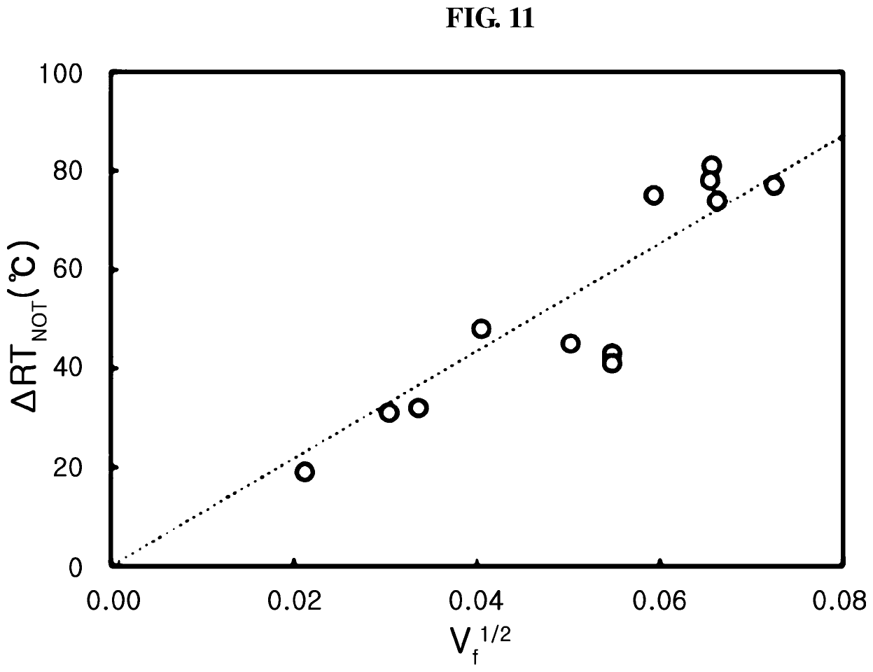

In FIG. 11, a clear linear relationship exists between the increasing amount of the RTNDT in pressure vessel surveillance test specimens and the atomic cluster volume fraction. Compressive stresses internally induced by entropy decrease compel the movement of atoms in the pressure vessel steel through diffusion. As this process unfolds, clusters of identical atoms form as they come together. With increasing compressive stresses, the volume of the formed clusters also increases, leading to a more pronounced elevation of the RTNDT. The data presented in FIG. 11 is derived from experimental observations on pressure vessel surveillance test specimens, confirming that the RTNDT of the pressure vessel shows an almost linear increase as the cluster volume grows. Referring to FIG. 11, it becomes evident that internal compressive stresses occur within the pressure vessel due to entropy decrease, compelling atoms to move and form clusters. This, in turn, shifts the RTNDT to higher temperatures. Therefore, the formation of atomic clusters serves as a signal that compressive stresses have internally developed within the material. An increase in the cluster volume fraction indicates the presence of higher compressive stresses.

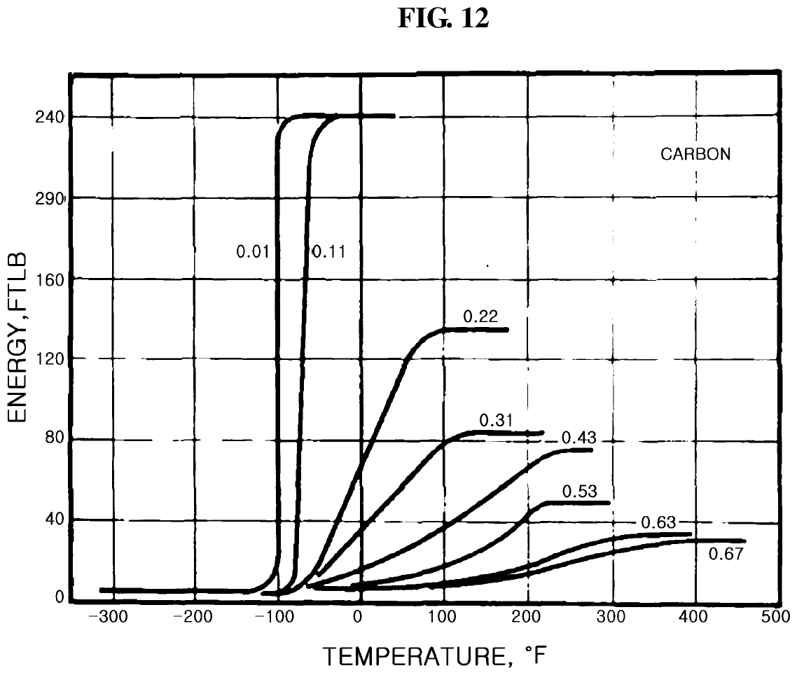

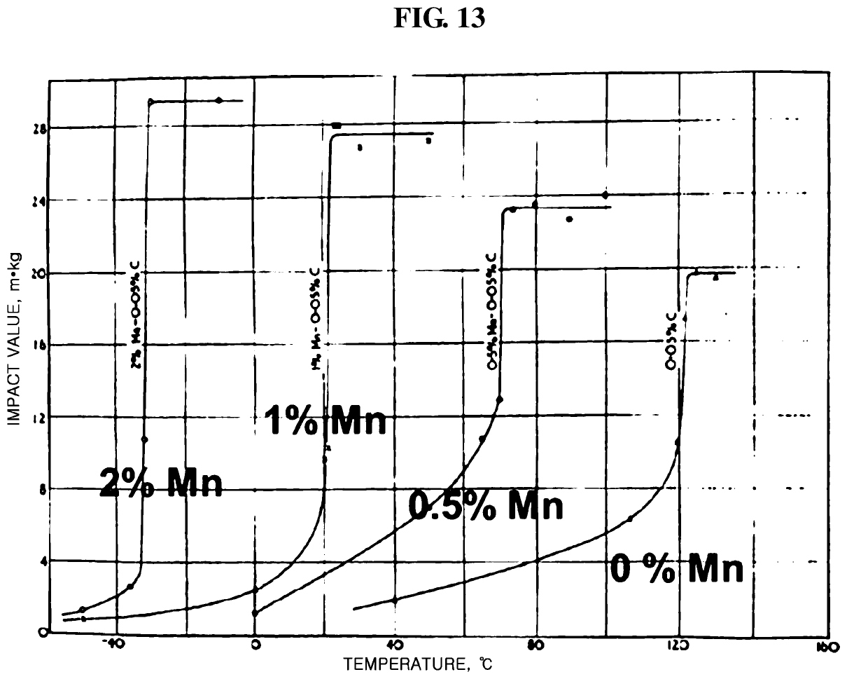

FIG. 12 depicts the impact energy behaviors of water-quenched carbon steel as a function of carbon content. Moving to FIG. 13, we observe the impact energy behaviors of Fe-0.05% C steel, annealed at 950° C. and water-quenched, as a function of manganese content.

The enthalpy release due to entropy decrease is highly sensitive to the chemical composition of the pressure vessel material. Specifically, a higher carbon content accelerates the formation of carbon clusters, leading to an intensified enthalpy release. Consequently, the internally generated compressive stress from enthalpy release becomes higher, causing the RTNDT (i.e., DBTT) to shift to higher values and the USE to decrease. Thus, the chemical composition of the pressure vessel material is closely linked to changes in both the RTNDT and the USE.

Referring to FIG. 12, we confirm the influence of carbon content on the impact energy of a water-quenched carbon steel. With increasing carbon content, the RTNDT of the steel shifts to higher values, while the USE decreases. This demonstrates that, during water quenching after annealing, the rapid formation of carbon clusters leads to a proportional increase in heat release, resulting in higher compressive stresses. As a consequence, the RTNDT shifts to higher temperatures, and simultaneously, the USE decreases.

Referring to FIG. 13, manganese (Mn) is shown to inhibit carbon cluster formation in carbon steel. When 2% Mn is added to a carbon steel containing 0.05% carbon, water quenched at 950° C., it significantly suppresses enthalpy release during quenching, resulting in excellent impact properties. Conversely, reducing the Mn content leads to inferior impact properties of the carbon steel, with the RTNDT shifting to higher temperatures and the USE decreasing. Furthermore, pressure vessels with higher copper (Cu) content exhibit relatively low impact energy because Cu atoms tend to form Cu clusters independently in an iron-rich matrix. These Cu clusters are associated with high enthalpy release, i.e., the high amount of entropy decrease, resulting in high compressive stresses. Therefore, the reason why pressure vessels with a high Cu content show low impact properties is due to the high compressive stresses induced by entropy decrease, leading to the formation of Cu clusters.

### <Experiment Example 4>: Physical Concept of Specific Heat Capacity, and a Comparison of Specific Heat Capacities and Young's Moduli of Unaged and Aged Asphalts after 50 h of Aging at 185° C.

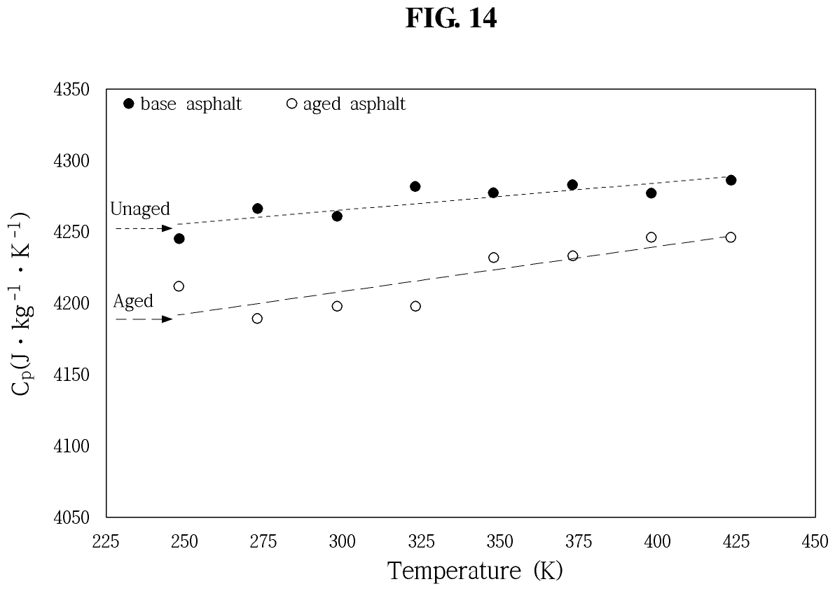

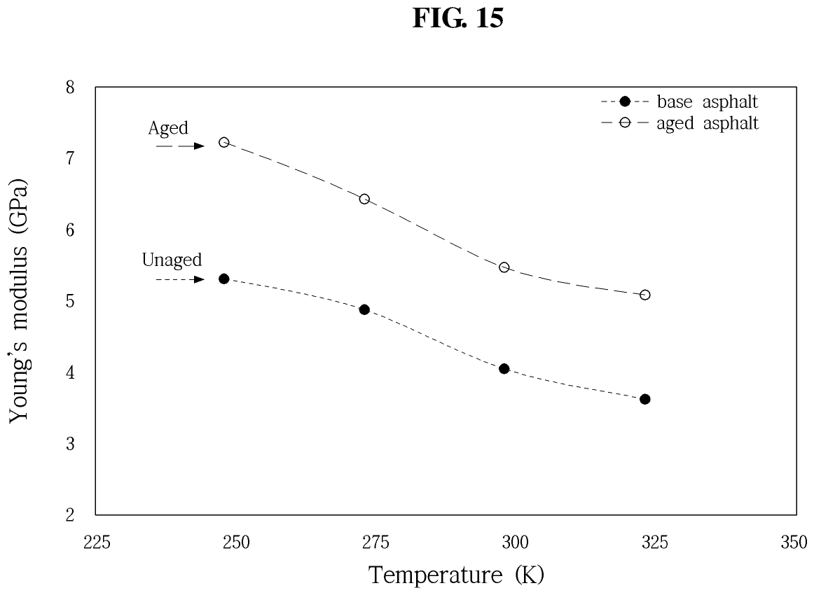

The specific heat capacity is a measure of how much heat or energy is required to raise the temperature of a unit mass of a substance by one degree Celcius or one Kelvin, expressed in units of J/(g·K). It is crucial to note that the unit of the specific heat capacity is the same as that of entropy, as shown in Eq. 1. This suggests that specific heat capacity reflects the entropy of the substance, which constitutes another great discovery of the present inventive concept. Consequently, the amount of entropy change can be directly determined by measuring the specific heat capacity of pressure vessels using DSC with aging time (operational time) and then assessing the level of changes in its specific heat capacity. As a typical example, the specific heat capacities of unaged and aged asphalts subjected to aging at 185° C. for 50 h are compared. FIG. 14 illustrates that the specific heat capacity of asphalt decreases after 50 hours of aging at 185° C., indicating a reduction in the asphalt's entropy following aging at 185° C. Referring to Eq. 3, the entropy decrease leads to the spontaneous generation of internal compressive stresses in the asphalt. Consequently, the aged asphalt must exhibit increased strength and higher hardness, as evident in FIG. 15, where a higher Young's modulus of aged asphalt is confirmed.

In today's nuclear industry, when the available surveillance test specimens are depleted, the lifespan diagnosis of pressure vessels is conducted by monitoring neutron fluence using alternate measures like ex-vessel neutron dosimetry. This approach operates on the assumption that key embrittlement criteria for the pressure vessel, including the RTNDT model and the USE model, function as conservative indicators even under conditions of high neutron fluence, as recommended by the U.S. Nuclear Regulatory Commission. Should this assumption prove to be non-conservative, the methodology for diagnosing pressure vessel lifespan-dependent on monitoring neutron fluence through ex-vessel neutron dosimetry-loses its significance. Hence, there arises a need for a novel technology capable of directly observing the embrittlement behavior of pressure vessels at elevated neutron fluence levels. To meet these technical requirements, a more accurate and secure method for assessing the embrittlement behavior of pressure vessels is proposed: the direct measurement of the accumulated amount of enthalpy released or absorbed within the pressure vessel or its specific heat capacity. This alternative offers a more precise and reliable approach compared to existing methods like ex-vessel neutron dosimetry.

To accomplish this, samples for calorimetric measurements are extracted from the base metal and weld region of the pressure vessel. The enthalpy content and specific heat capacity of the pressure vessel are then measured using a DSC. By utilizing the correlation between the enthalpy content or the specific heat capacity and the RTNDT as well as the USE, the RTNDT and USE values of the pressure vessel can be directly determined. Directly assessing the embrittlement of the pressure vessel through the measurement of enthalpy content or specific heat capacity eliminates potential conservatism reductions in the pressure vessel's embrittlement criteria, especially at high neutron fluence. However, extracting calorimetric samples at the ¼ thickness location of the pressure vessel, a well-known conservative location concerning pressure vessel embrittlement, is practically challenging. Therefore, the RTNDT and USE values determined based on enthalpy content measurements taken from the inner surface, are adjusted by considering the conservatism associated with the slow cooling rate and reduced neutron irradiation at the ¼ thickness location.

The various embodiments and terminology used in the present inventive concept are not intended to limit the technology disclosed herein to any particular embodiment but should be understood to encompass various modifications, equivalents, and/or alternatives to the described embodiments. Regarding the descriptions in the drawings, similar reference numerals may be used for similar components. Singular expressions may include plural representations unless explicitly stated otherwise in the context. In the present inventive concept, expressions such as ‘A or B’ ‘at least one of A and B’, ‘A, B, or C’ or ‘at least one of A, B, and C,’ may include all possible combinations of the listed items. Expressions like ‘first’, ‘second,’ ‘firstly,’ or ‘secondly,’ among others, are used to describe components without limiting them based on order or importance and are only used to distinguish one component from another. When a component (e.g., the first component) is mentioned as being ‘ (functionally or communicatively) connected (e.g., to the second component),’ it means that the mentioned component can be connected directly to the other component or through another component (e.g., the third component).

1. A method for diagnosing the remaining lifespan of a pressure vessel comprising the steps of:
extracting a calorimetric sample from the pressure vessel;
measuring the enthalpy amount, changes in the enthalpy amount of the extracted calorimetric sample, the specific heat capacity, or changes in the specific heat capacity of the extracted calorimetric sample;
determining the amount of entropy change in the calorimetric sample based on the measured enthalpy amount, the measured changes in enthalpy amount, the measured specific heat capacity, or the measured changes in the specific heat capacity; and
determining the remaining lifespan of the pressure vessel based on the determined amount of entropy change in the calorimetric sample.

2. The method of claim 1, wherein the step of determining the remaining lifespan of the pressure vessel is performed based on at least one of the reference temperature for nil ductility transition temperature (RTNDT) and the Upper Shelf Energy (USE).

3. The method of claim 1, wherein the calorimetric sample is extracted from the inner surface of the pressure vessel, and
wherein the step of determining the remaining lifespan of the pressure vessel comprises the steps of:
determining the RTNDT or the USE of the calorimetric sample, and
adjusting the determined RTNDT or USE by taking into account the temperature and neutron fluence at a ¼ thickness location of the pressure vessel.

4. The method of claim 2, wherein the step of determining the remaining lifespan of the pressure vessel is conducted using the following lifespan diagnosis solution:
[Lifespan Diagnosis Solution]:
$${t}_{L} = {k ( {H}_{L} / {H}_{O} ) [ ( {T}_{P} - T ) / {T}_{P} ]}^{2} exp [ {Q}_{Δ S} / R ( 1 / T - 1 / {T}_{P} ) ] or$$
$${t}_{L} = {k ( \vert Δ {S}_{L} \vert / \vert Δ {S}_{0} \vert ) [ ( {T}_{P} - T ) / {T}_{P} ]}^{2} exp [ {Q}_{Δ S} / R ( 1 / T - 1 / {T}_{P} ) ]$$
where, k is a constant, Q_{ΔS} represents the activation energy for entropy decrease, T is the operating temperature, T_{P} is the peak temperature where the maximum enthalpy amount is released, H_{L} is a threshold enthalpy amount determined by the smaller value between reaching the RTNDT of 93° C. and reaching the USE of 68 J for the pressure vessel or a surveillance test specimen, H₀ is the enthalpy amount measured at any given time for the pressure vessel or a surveillance test specimen, |ΔS_{L}| is the absolute value of the threshold entropy change or the threshold entropy, determined by the smaller value between reaching the RTNDT of 93° C. and reaching the USE of 68 J for the pressure vessel or a surveillance test specimen, |ΔS₀| is the absolute value of entropy change or entropy at any given time, and |ΔS_{L}| and |ΔS₀| are determined from the measured specific heat capacity or the measured changes in the specific heat capacity.

5. The method of claim 1, wherein the pressure vessel refers to a pressure vessel comprising a nuclear reactor pressure vessel situated inside a nuclear reactor, or a pressure vessel that includes Type A pressure vessels as defined in Safety Inspection Notice 2020-43 in the Republic of Korea.

6. The method of claim 4, further comprising the step of verifying the lifespan diagnosis solution,
wherein the step of verifying the lifespan diagnosis solution comprises the step of:
determining the enthalpy amount of a pressure vessel surveillance test specimen using the lifespan diagnosis solution, and
comparing the determined enthalpy amount with the measured enthalpy amount of the pressure vessel surveillance test specimen.

7. The method of claim 3, wherein if extracting the calorimetric sample from the inner wall surface of the pressure vessel is not possible due to cladding, the calorimetric sample is obtained instead from a pressure vessel surveillance test specimen, and the steps of determining the entropy change in the pressure vessel and determining the remaining lifespan of the pressure vessel based on the entropy change are then performed using the calorimetric sample extracted from the pressure vessel surveillance test specimen.
